(19) United States
(12) Patent Application Publication
(10) Pub. No.: US 2015/0034346 A1
(43) Pub. Date: Feb. 5, 2015

(54) Impact Tool

(71) Applicant: Hitachi Koki Cp., Ltd., Tokyo (JP)

(72) Inventors: Norihide Tao, Hitachinaka (JP); Hiroto Inagawa, Hitachinaka (JP); Hideki Watanabe, Hitachinaka (JP)

(21) Appl. No.: 14/358,172

(22) PCT Filed: Mar. 25, 2013
(86) PCT No.: PCT/JP2013/002016

§ 371 Date: May 14, 2014

(30) Foreign Application Priority Data
Mar. 30, 2012 (JP) 2012-080602

(51) Int. Cl. B25B 21/02; B25B 23/00; B25B 13/06

(52) U.S. Cl. CPC B25B 21/02; B25B 13/065; B25B 23/0035
USPC 173/93; 173/109

(57) ABSTRACT

An impact tool comprises an end-bit holding section (3a) and a driving source (2). The end-bit holding section is formed with a hole (3a) for receiving an end bit (12), the hole having a center axis defining an axial direction, the hole having one end in the axial direction functioning as an end-bit insertion opening (3c) for passing the end bit therethrough, the hole having a generally polygonal cross section perpendicular to the axial direction. The driving source is configured to rotate the end-bit holding section. An arc-shaped cutout (3g) is formed at each apex angle of the hole in proximity to the end-bit insertion opening such that the arc-shaped cutout has a largest arc dimension at the opening (3c) and the arc dimension decreases gradually from the opening toward another end of the hole in the axial direction.

### TECHNICAL FIELD

The invention relates to an impact tool that generates rotational striking force for performing work such as fastening and loosening of screws, etc.

### BACKGROUND ART

An impact tool generates rotational striking force using a motor as the driving source for performing work such as fastening and loosening of screws, etc. by rotating an end bit while intermittently applying striking force to the end bit. Because the impact tool has features of small counteraction, high fastening performance, and the like, the impact tool is widely used recently. This impact tool is described in Japanese Patent Application Publication No. 2010-253577.

### CITATION LIST

### Patent Literature

PTL 1: Japanese Patent Application Publication 2010-253577

### DISCLOSURE OF INVENTION

### Solution to Problem

As shown in FIG. 8, an end bit 12 has a regular hexagonal shape in cross-section. An anvil 3 is formed with a regular hexagonal hole 3a that is slightly larger than the cross-sectional area of the end bit 12, thereby constituting an end-bit holding section. In work using such an impact tool, when rotational striking force is applied to the end bit 12, the end bit 12 rotates with respect to the regular hexagonal hole 3a, a portion of the end bit 12 adjacent to an apex angle 12a then contacts a wall surface of the regular hexagonal hole 3a. As result, a large contact load is generated at the contact portion. Further, the contact load becomes the largest at a front end portion of the anvil at an end-bit insertion opening side. Thus, large stress is generated at a front end portion of a regular hexagonal apex angle 3b forming the end-bit holding section and, at the time of performing work such as fastening and loosening of screws, large stress is generated repeatedly at the front end portion of the regular hexagonal apex angle 3b. Because fastening of a screw or a bolt having a large diameter requires large torque, the above-mentioned stress becomes excessive. In a test under a severe condition where fastening of a screw or a bolt having a large diameter is performed continuously, because excessive stress is generated repeatedly, fatigue failure sometimes happens from the front end portion of the regular hexagonal apex angle of the end-bit holding section.

Especially recently, due to increasing of voltage of a battery which is the power source and to increasing of output power of a motor which is the driving source, use conditions of the anvil is getting severe. On the other hand, because a hexagonal shaft shape of an end bit is specified by a standard and because an impact tool which is a hand-held tool has a high demand of downsizing and lightweight from the market, a countermeasure such as increasing shaft diameter of the anvil to reduce stress cannot be taken without careful consideration. Further, the market also requires an improvement in low-vibration and low-noise performance considering comfort in a work environment and an improvement in highly-efficient striking performance considering energy conservation. Accordingly, it is an important task to provide an impact tool that maintains low-vibration, low-noise, and highly-efficient striking performance while improving a product's life.

In view of the foregoing, an object of the invention is to provide an impact tool that can achieve reduction of stress in an end-bit holding section and that can extend the product's life.

The present invention features an impact tool comprising: an end-bit holding section formed with a hole for receiving an end bit, the hole having a center axis defining an axial direction, the hole having one end in the axial direction functioning as an end-bit insertion opening for passing the end bit therethrough, the hole having a generally polygonal cross section perpendicular to the axial direction; and a driving source configured to rotate the end-bit holding section, characterized in that an arc-shaped cutout is formed at each apex angle of the hole in proximity to the end-bit insertion opening such that the arc-shaped cutout has a largest arc dimension at the opening and the arc dimension decreases gradually from the opening toward another end of the hole in the axial direction.

Preferably, the generally polygonal cross section of the hole has a substantial polygonal profile comprising an arc-shaped portion corresponding to the arc-shaped cutout, and a linear portion between adjacent arc-shaped portions, the linear portion being connected to the arc-shaped portion through a connecting portion, and the connecting portion is configured to contact with the end bit, while the arc-shaped portion is at a distance from the end bit, when the end-bit holding section is rotated.

Preferably, the impact tool further comprises an anvil and a rotational striking mechanism including a spindle and a hammer. The end-bit holding section is provided on the anvil. The driving source comprises a motor for rotating the spindle. The rotational striking mechanism is configured to generate rotational striking force and to intermittently transmit the rotational striking force from the hammer via the anvil to the end bit, thereby applying the rotational striking force to the end bit.

Preferably, the end-bit holding section comprises a first portion including the opening and a second portion including the another end, the arc-shaped cutout being formed exclusively at the first portion.

Preferably, the second portion has a regular polygonal cross-section perpendicular to the axial direction, the regular polygonal cross section having an area greater than an area of a cross-section of the end-bit perpendicular to the axial direction.

Preferably, the first portion has a length of 5.0-5.5 mm from the opening in the axial direction.

Preferably, the hole has a regular hexagonal cross-section perpendicular to the axial direction.

### Advantageous Effects of Invention

According to the impact tool of the invention, an arc-shaped cutout is efficiently formed, only at necessary positions, at each apex angle of a regular hexagonal hole constituting an end-bit holding section of the anvil such that the arc-shaped cutout has a largest arc dimension at a front end at an end-bit insertion opening side and that the arc dimension decreases gradually from the front end toward the motor side. With this configuration, it is possible, without weakening holding performance of the end bit, to prevent increases in vibrations and noises and to prevent a loss of transmission when the anvil and the end bit make striking contact with each other, and to reduce stress and improve the product's life of the anvil. Further, the above-described arc-shaped cutout has a grade from the front end of the end-bit insertion opening side toward the motor side toward the motor side. Thus, friction resistance against a forging die decreases during manufacturing of the anvil, and the product's life of the forging die can be increased. Accordingly, it is possible to provide an impact tool that can maintain low-vibration, low-noise, and highly-efficient striking performances and that can improve reliability in a compatible manner, and that is inexpensive in manufacturing cost.

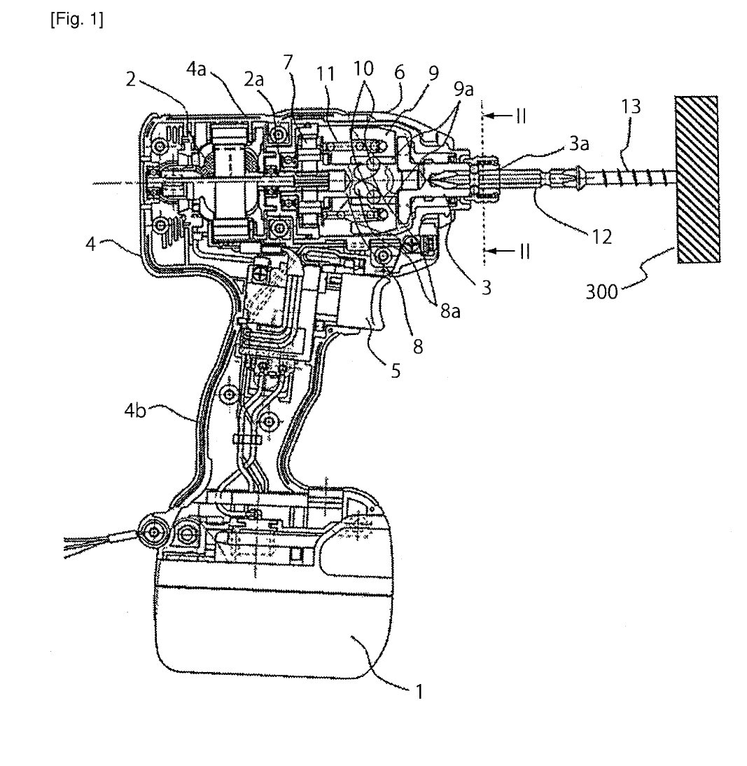

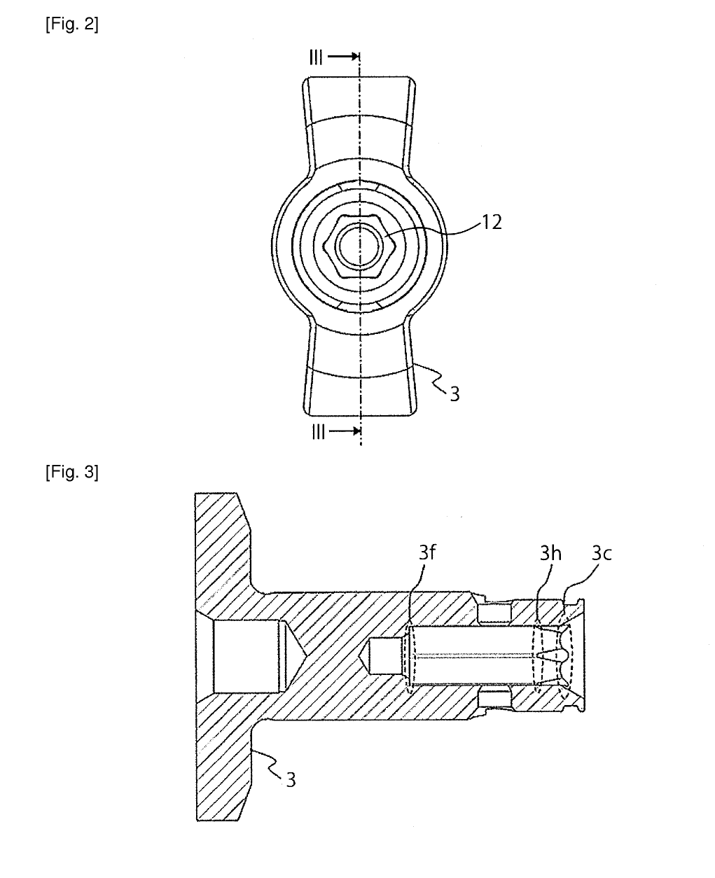

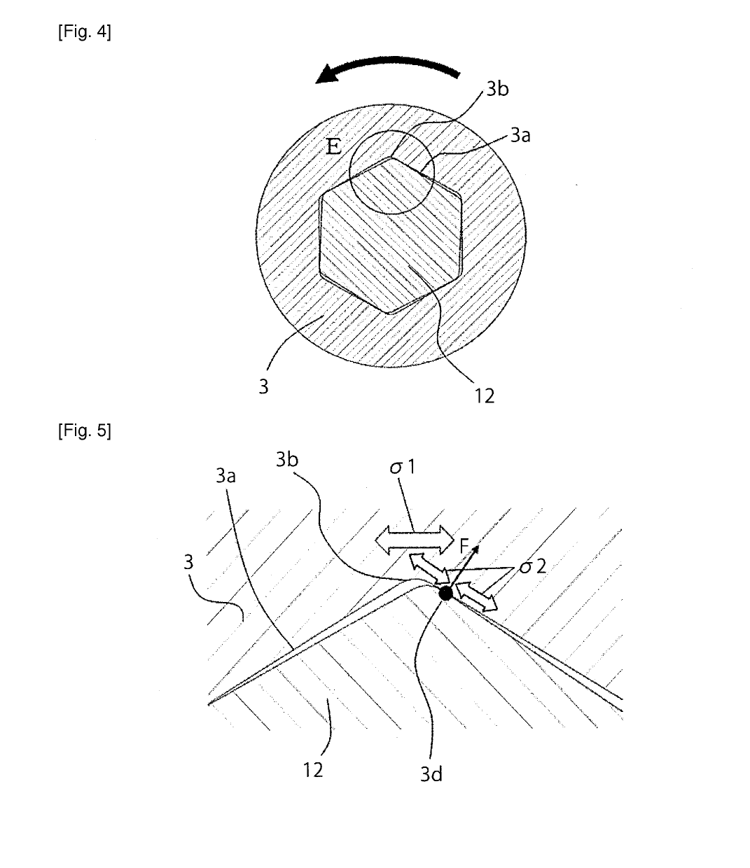

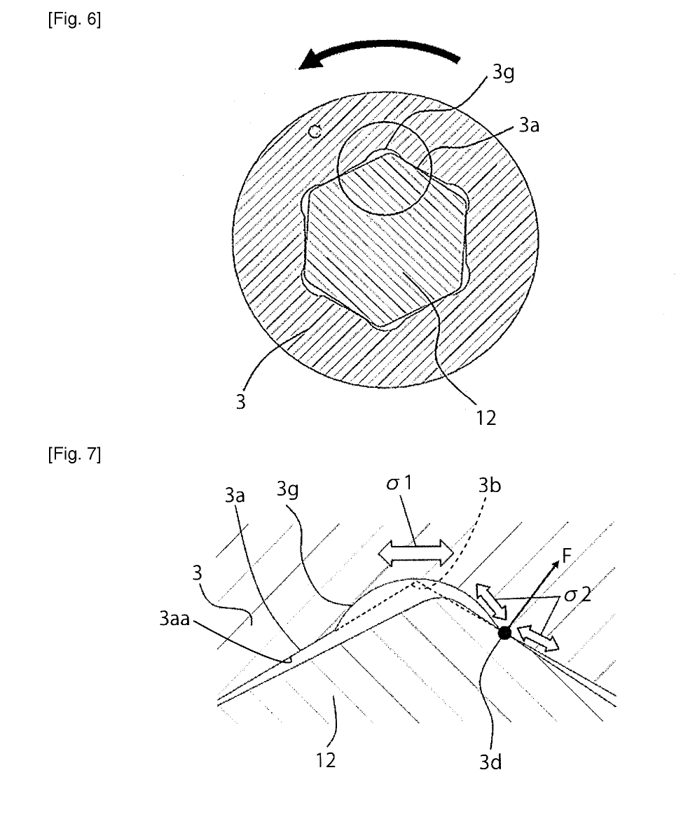

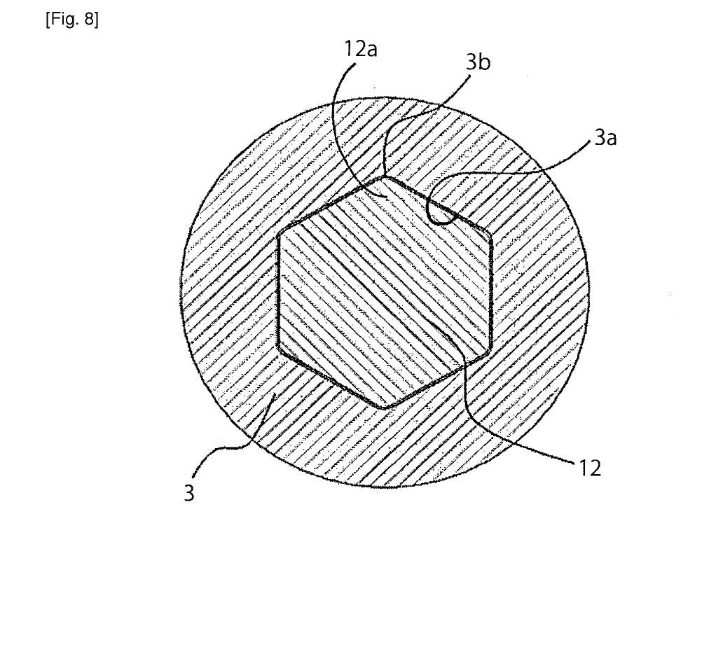

### BRIEF DESCRIPTION OF DRAWINGS

[FIG. 1]FIG. 1 is a side cross-sectional view showing an overall structure of an impact tool according to an embodiment of the invention;

[FIG. 2]FIG. 2 is a front view of an anvil and an end bit of the impact tool according to the embodiment of the invention;

[FIG. 3]FIG. 3 is a cross-sectional view taken along a line III-III in FIG. 2.

[FIG. 4]FIG. 4 is a cross-sectional view showing an engaging state between the front-end anvil at an end-bit insertion opening side and the end bit during screw fastening according to the embodiment of the invention;

[FIG. 5]FIG. 5 is an enlarged view of C-part in FIG. 4;

[FIG. 6]FIG. 6 is a cross-sectional view showing an engaging state between the anvil and the end bit in 3h-3f in FIG. 3, during screw fastening according to the embodiment of the invention;

[FIG. 7]FIG. 7 is an enlarged view of E-part in FIG. 6; and

[FIG. 8]FIG. 8 is a cross-sectional view showing an anvil and an end bit in a conventional impact tool.

### BEST MODE FOR CARRYING OUT THE INVENTION

The overall configuration of an impact tool according to an embodiment of the invention will be described below while referring to FIG. 1.

The impact tool of the present embodiment is a cordless hand-held type tool. The impact tool includes a battery 1 that can be charged and discharged repeatedly as the power source, a motor 2 that drives a rotational striking mechanism as the driving source, and an anvil 3 to which rotational force and striking force are applied intermittently. Here, the anvil 3 is provided with an end-bit holding section 3a constituted by a regular hexagonal hole 3A. The hole 3A is configured to receive an end-bit 12. The hole 3A has center axis defining an axial direction. The end-bit 12 has a hexagonal shaft extending in the axial direction when the end-bit 3A is received in the hole 3A. The hole 3A has a hexagonal cross section that is slightly larger than a cross-sectional shape of an end bit 12. The end bit 12 is configured to be inserted into the end-bit holding section 3a from a front end portion 3c, i.e., an end-bit insertion opening. And then the end bit 12 is held by and attached to the end-bit holding section 3a. In another embodiment, the hole 3A may have a polygonal cross section perpendicular to the axial direction.

As described above, rotational striking force transmitted from the rotational striking mechanism to the anvil 3 causes the end-bit holding section 3a and a hexagonal shaft section of the end bit 12 to engage each other in a rotational direction, thereby transmitting rotational striking force to a screw 13 for performing work such as fastening and loosening of screws, etc.

The motor 2 is accommodated within a body section 4a of a housing 4. A switch 5 is provided at an upper portion of a handle section 4b extending downward integrally from the body section 4a of the housing 4. The switch 5 turns on/off power from the battery 1 to the motor 2 so as to start/stop the motor 2, and also has a control function of selecting the rotational direction of the motor 2 between a fastening direction and a loosening direction of the screw 13.

In the rotational striking mechanism accommodated within a hammer case 6, rotation of an output shaft 2a of the motor 2 is decelerated via a planetary gear mechanism 7 and is transmitted to a spindle 8, so that the spindle 8 is driven to rotate at a predetermined speed. The spindle 8 has a rotational axis defining an axial direction. Here, the spindle 8 and a hammer 9 are coupled via a cam mechanism. The cam mechanism has V-shaped spindle cam grooves 8a formed on an outer circumferential surface of the spindle 8, V-shaped hammer cam grooves 9a formed on an inner circumferential surface of the hammer 9, and balls 10 engaging the spindle cam grooves 8a and the hammer cam grooves 9a.

The hammer 9 is constantly urged forward (the rightward in FIG. 1) by a spring 11 and, in a stopped state, the hammer 9 is located at a position away from an end surface of the anvil 3 with a gap therebetween due to engagement of the balls 10 and the cam grooves 8a, 9a. Convex sections (not shown) are provided at two positions in a symmetrical manner on respective opposing rotational planes of the hammer 9 and the anvil 3.

When the spindle 8 is driven to rotate as described earlier, this rotation is transmitted to the hammer 9 via the above-described cam mechanism. Before the hammer 9 makes a half turn, the convex sections of the hammer 9 engage the convex sections of the anvil 3 to rotate the anvil 3. When engaging reaction force at that time causes relative rotation between the spindle 8 and the hammer 9, the hammer 9 starts moving rearward toward the motor 2 side while compressing the spring 11 along the spindle cam grooves 8a of the cam mechanism. Then, when rearward movement of the hammer 9 causes the convex sections of the hammer 9 to get over the convex sections of the anvil 3 and engagement of the both convex sections are released, the hammer 9 is accelerated rapidly in the rotational direction and in the forward direction due to elastic energy accumulated in the spring 11 and action of the cam mechanism as well as the rotational force of the spindle 8, while moving forward due to the urging force of the spring 11. And the convex sections of the hammer 9 engage the convex sections of the anvil 3 again and starts rotating together. At this time, because strong rotational striking force is applied to the anvil 3, the rotational striking force is transmitted to the screw 13 via the end bit 12 mounted on the anvil 3.

Thereafter, similar operations are repeated to transmit rotational striking force intermittently and repeatedly from the end bit 12 to the screw 13, and the screw 13 is driven into a workpiece 300 such as wood. When the screw 13 is to be loosened, the above-described operations are applied except that the rotational direction is opposite, and hence repetitive descriptions are omitted.

In the present embodiment, the regular hexagonal hole 3A constituting the end-bit holding section 3a of the anvil 3 extends in the axial direction. The regular hexagonal hole 3A has one end as the opening 3c and the other end opposed to the one end in the axial direction. Each apex angle of the regular hexagonal hole 3A has an arc shape, referring to FIG. 3. Further, the cutout 3g has an arc shape that has the largest arc dimension at the front end portion 3c at the end-bit insertion hole, that has arc dimension that gradually decreases from the front end portion 3c toward the motor side, and that has the smallest arc dimension at a position 3h that is shifted from the front end portion 3c toward the motor side (a cutout shape of the smallest arc dimension has the same shape as the hexagonal apex angle 3b of the end-bit holding section). In the present invention, the arc dimension means a radius of curvature of the arc shape of the cutout 3g.

In this embodiment, the hole 3A has a substantial hexagonal cross section perpendicular to the axial direction. The cross section has a substantial hexagonal profile. The hexagonal profile has an arc-shaped portion 3g corresponding to the cutout 3g, and a linear portion 3aa between adjacent arc-shaped portions 3g. The arc-shaped portion 3g is connected to the linear portion 3aa through a contact portion 3d.

Also, an arc-shaped cutout is not formed at each apex angle from the position 3h at which the arc-shaped cutout 3g has the smallest arc dimension to the rear end portion 3f toward the motor side. That is, this section has the same shape as the hexagonal apex angle 3b of the end-bit holding section of the anvil 3. As shown in FIG. 3, the position 3h is between the front end portion 3c and the rear end portion 3f, and the position 3h is closer to the front end portion 3c than to the rear end portion 3f. Preferably, the position 3h is at a distance of 5.0-5.5 mm from the front end portion 3c.

A comparative example 1 will be described in which the cross-sectional shape of the holding hole is uniform from an end-bit insertion hole 3c side to a motor-side deepest portion 3f, and is a regular hexagonal hole that is slightly larger than the cross-sectional shape of the end bit.

At the time of fastening a screw, when rotational striking force is applied to the end bit 12, the hexagonal shaft of the end bit 12 rotates relative to the hexagonal hole of the end-bit holding section 3a provided at the anvil 3, and the hexagonal shaft and the hexagonal hole contact each other at a contact portion 3d adjacent to the regular hexagonal apex angle 3b. And a large contact load F is generated at the contact portion 3d. This contact causes torsional deformation at the anvil 3, and stress sigma-1 is generated at the regular hexagonal apex angle 3b in a direction indicated by the arrow in FIG. 5 (circumferential direction). Because the contact portion 3d is locally subjected to the contact load F, compression deformation is generated locally at the contact portion 3d and, due to the compression deformation, stress sigma-2 is generated at a portion that is just proximal to the contact portion 3d. The load F generated at the contact portion 3d becomes larger, as the contact portion 3d is becoming closer to the front end portion 3c. The contact load F is the largest at the front end portion 3c at the end-bit insertion hole side. The applicant has found the above load distribution by implementing Computer Aided Engineering (CAE) using finite element analysis. Hence, at the front end portion 3c of the regular hexagonal apex angle 3b of the end-bit holding section 3a, the stress sigma-1 and the stress sigma-2 are added and excessive stress sigma-3 is generated.

Next, a comparative example 2 will be described while referring to FIGS. 6 and 7 in which the cross-sectional shape of the holding hole is uniform from the end-bit insertion hole 3c side to the motor-side deepest portion 3f, and is formed with arc-shaped cutout 3g at the outer side of the regular hexagonal hole for reducing the above-described excessive stress.

As in the comparative example 1, large stress is generally generated at an intersecting portion of two straight lines having an angle (particularly, in case of an acute angle). Thus, in the comparative example 2, an arc shape 3g is provided adjacent to the two lines for reducing stress.

The arc-shaped cutout 3g for reducing stress is formed at the outer side of an apex portion of the regular hexagonal hole at which large stress is generated during work of fastening and loosening of screws. Here, in case of the end-bit holding section 3a provided at the anvil 3 of the impact tool, if an arc shape is formed so as to be inscribed between two line-segments forming the hexagonal shape in proximity to the regular hexagonal apex angle 3b, a problem occurs that the arc shape interferes with the end bit 12 and the end bit 12 cannot be inserted. Hence, as shown in FIG. 7, the arc-shaped cutout 3g is formed at the outer side of the regular hexagonal hole constituting the end-bit holding section 3a. In the comparative example 2, the arc-shaped cutout 3g is formed uniformly from the front end portion 3c at the end-bit insertion hole side to the rear end portion 3f at the motor side, at the outer side of the apex portion of the regular hexagonal hole at which large stress is generated during work of fastening and loosening of screws. Preferably, the hexagonal profile of the cross section has an arc-shaped portion 3g corresponding to the cutout 3g, and a linear portion 3aa between adjacent arc-shaped portions 3g. The arc-shaped portion 3g is connected to the linear portion 3aa through a contact portion 3d.

With this configuration, stress can be reduced during work of fastening and loosening of screws, compared with the end-bit holding section 3a having a shape of the regular hexagonal apex angle 3b in the comparative example 1. However, in the end-bit holding section 3a at which the arc-shaped cutout 3g is formed uniformly from the front end portion 3c at the end-bit insertion hole side to the rear end portion 3f at the motor side at the outer side of the apex portion of the regular hexagonal hole, compared with the comparative example 1, the amount of gap between the anvil 3 and the end bit 12 increases and performance of holding the end bit decreases. Hence, problems occur that vibrations and noises increase when the anvil 3 and the end bit 12 strikingly contact each other, and that a loss in transmission of rotational striking force occurs.

In the present embodiment, each apex angle of the regular hexagonal hole constituting the end-bit holding section 3a of the anvil 3 has an arc shape, referring to FIG. 3. Further, the cutout 3g has an arc shape that has the largest arc dimension at the front end portion 3c at the end-bit insertion hole, that has arc dimension that gradually decreases from the front end portion 3c toward the motor side, and that has the smallest arc dimension at a position 3h that is shifted from the front end portion 3c toward the motor side (a cutout shape of the smallest arc dimension has the same shape as the hexagonal apex angle 3b of the end-bit holding section). Also, an arc-shaped cutout is not formed at each apex angle from the position 3h at which the arc-shaped cutout 3g has the smallest arc dimension to the rear end portion 3f toward the motor side. That is, this section has the same shape as the hexagonal apex angle 3b of the end-bit holding section of the anvil 3. As shown in FIG. 3, the position 3h is between the front end portion 3c and the rear end portion 3f, and the position 3h is closer to the front end portion 3c than to the rear end portion 3f. Preferably, the position 3h is at a distance of 5.0-5.5 mm from the front end portion 3c.

Further, the contact portion 3d of the hole 3A contacts a portion on a side-face away from the apex angle of the end bit 12, so that damage to the end bit 12 by the anvil 3 can be reduced.

This configuration provides a structure that the amount of gap between the anvil and the end bit does not increase and that stress is reduced. The operations of the impact tool having the above-described structure will be described.

The rotational striking mechanism driven by the motor 2 which is the driving source transmits rotational striking force to the anvil 3. And the rotational striking force is transmitted to a screw via the end bit 12 for performing screw fastening work. The regular hexagonal shaft of the end bit 12 rotates relative to the regular hexagonal hole constituting the end-bit holding section 3a of the anvil 3. The regular hexagonal shaft and the regular hexagonal hole contact each other adjacent to an apex of the regular hexagonal shape, thereby transmitting the rotational striking force to the screw.

At this time, FIGS. 6 and 7 show an engaging state adjacent to the front end of the arc-shaped cutout 3g that has the largest arc dimension at the front end at the end-bit insertion hole side. Contact between the anvil 3 and the end bit 12 causes torsional deformation at the anvil 3, and the stress sigma-1 is generated in proximity to the arc-shaped cutout 3g in the direction indicated by the arrow in FIG. 6 (circumferential direction). Because the contact portion 3d is locally subjected to the contact load F, compression deformation is generated locally at the contact portion 3d and, due to the compression deformation, the stress sigma-2 is generated at a portion that is just proximal to the contact portion 3d. The stress sigma-1 and the stress sigma-2 are added and excessive stress sigma-3 is generated. However, due to the arc-shaped cutout 3g, generation of excessive stress due to stress concentration is suppressed.

Further, the arc-shaped cutout from the position 3h at which the arc-shaped cutout 3g has the smallest arc dimension to the rear end portion 3f toward the motor side has the same shape as the regular hexagonal apex angle 3b of the conventional end-bit holding section, and an engaging state is a state shown in FIGS. 4 and 5, like the conventional impact tool. Contact between the anvil 3 and the end bit 12 causes torsional deformation at the anvil 3, and the stress sigma-1 is generated at the regular hexagonal apex angle 3b in the direction indicated by the arrow in FIG. 4 (circumferential direction). Because the contact portion 3d is locally subjected to the contact load F, compression deformation is generated locally at the contact portion 3d and, due to the compression deformation, the stress sigma-2 is generated at a portion that is just proximal to the contact portion 3d. At this time, because this portion is away from the front end portion at the end-bit insertion hole side where the maximum contact load is generated, the contact load F is suppressed and the stress sigma-2 is suppressed. Although the stress sigma-1 and the stress sigma-2 are added and the stress sigma-3 is generated, due to the small contact load F, generation of excessive stress is suppressed.

The amount of gap between the anvil 3 and the end bit 12 from the position 3h at which the arc-shaped cutout 3g has the smallest arc dimension to the rear end portion 3f toward the motor side is the same as the amount of gap between the conventional anvil 3 and the end bit 12. This prevents weakening of holding performance of the end bit. Further, the arc-shaped cutout 3g has a grade from the front end portion at the end-bit insertion hole side toward the motor side, and friction resistance against the forging die is reduced during manufacture of the anvil. This reduces wear of the forging die, and improves product's life of the forging die.

As described above, in the anvil 3 according to the invention, the arc-shaped cutouts 3g are efficiently formed only at necessary positions for the purpose of reducing stress that is generated at the end-bit holding section 3a due to repetitive screw fastening and loosening. This prevents an increase of the amount of gap between the anvil and the end bit, enables a design with which stress can be reduced, and improves product's life of the forging die at manufacture of the anvil. This prevents weakening of holding performance of the end bit, prevents an increase in vibrations and noises when the anvil strikingly contacts the end bit and a loss in transmission of rotational striking force, realizes reduction of stress, improves product's life of the anvil, and improves product's life of the forging die, so that an inexpensive anvil can be supplied. With the anvil 3 according to the invention, it is possible to provide an impact tool that can maintain low-vibration, low-noise, and highly-efficient striking performances and that can improve reliability in a compatible manner, and that is inexpensive in manufacturing cost. Note that, in the above-described embodiment, a cordless impact tool using a battery as the power source is described. However, the invention can be also applied to an impact tool that is driven by commercial AC power and to an impact tool that is driven by compressed air.

Having described the invention as related to the embodiment shown in the accompanying drawing, the invention is not limited by any of details of description, unless otherwise specified, but rather be constructed within its spirits and scope as set forth in the accompanying claims.

### REFERENCE SIGN LIST

1 battery

2 motor

2a motor output shaft

3 anvil

3A hexagonal hole

3a end-bit holding section

3b regular hexagonal apex angle

3c front end portion of end-bit holding section

3d contact portion between end bit and end-bit holding section

3e arc-shaped cutout

3f rear end portion of end-bit holding section

3g arc-shaped cutout according to the invention

3h position of the smallest arc dimension

4 housing

4a body section of housing

4b handle section

5 switch

6 hammer case

7 planetary gear mechanism

8 spindle

8a spindle cam groove

9 hammer

9a hammer cam groove

10 ball

11 spring

12 end bit

13 screw

1. An impact tool comprising:
an end-bit holding section formed with a hole for receiving an end bit, the hole having a center axis defining an axial direction, the hole having one end in the axial direction functioning as an end-bit insertion opening for passing the end bit therethrough, the hole having a generally polygonal cross section perpendicular to the axial direction; and
a driving source configured to rotate the end-bit holding section, characterized in that an arc-shaped cutout is formed at each apex angle of the hole in proximity to the end-bit insertion opening such that the arc-shaped cutout has a largest arc dimension at the opening and the arc dimension decreases gradually from the opening toward another end of the hole in the axial direction.

2. The impact tool according to claim 1, characterized in that
the generally polygonal cross section of the hole has a substantial polygonal profile comprising an arc-shaped portion corresponding to the arc-shaped cutout, and a linear portion between adjacent arc-shaped portions, the linear portion being connected to the arc-shaped portion through a connecting portion, and
the connecting portion is configured to contact with the end bit, while the arc-shaped portion is at a distance from the end bit, when the end-bit holding section is rotated.

3. The impact tool according to claim 1, further comprising an anvil and a rotational striking mechanism including a spindle and a hammer, and characterized in that:
the end-bit holding section is provided on the anvil,
the driving source comprises a motor for rotating the spindle,
the rotational striking mechanism is configured to generate rotational striking force and to intermittently transmit the rotational striking force from the hammer via the anvil to the end bit, thereby applying the rotational striking force to the end bit.

4. The impact tool according to claim 3, characterized in that the end-bit holding section comprises a first portion including the opening and a second portion including the another end, the arc-shaped cutout being formed exclusively at the first portion.

5. The impact tool according to claim 4, characterized in that the second portion has a regular polygonal cross-section perpendicular to the axial direction, the regular polygonal cross section having an area greater than an area of a cross-section of the end-bit perpendicular to the axial direction.

6. The impact tool according to claim 4, characterized in that the first portion has a length of 5.0-5.5 mm from the opening in the axial direction.

7. The impact tool according to claim 1, characterized in that the hole has a regular hexagonal cross-section perpendicular to the axial direction.
